(19) United States
(12) Patent Application Publication
(10) Pub. No.: US 2020/0203847 A1
(43) Pub. Date: Jun. 25, 2020

(54) ANTENNA/RADOME ASSEMBLY

(71) Applicant: Bombardier Inc., Dorval (CA)

(72) Inventors: Victor Daniel Gheorghian, Montreal (CA); Robert Grant, Toronto (CA)

(21) Appl. No.: 16/723,613

(22) Filed: Dec. 20, 2019

Related U.S. Application Data
(60) Provisional application No. 62/782,962, filed on Dec. 20, 2018.

(51) Int. Cl. H01Q 19/19; H01Q 1/28; H01Q 3/08; H01Q 15/16

(52) U.S. Cl. CPC H01Q 19/19; H01Q 15/16; H01Q 3/08; H01Q 1/288

(57) ABSTRACT

An assembly for an aircraft having a radome configured to be integrated into an upper vertical stabilizer, a first and second reflector positioned within an inner cross-sectional width of the radome, and an antenna positioning system. The first and second reflectors each respectively have a first and second surface area and each are respectively coupled to a first and second telescoping arm configured to move in a vertical direction. Each reflector is configured to focus radio waves. The antenna positioning system is configured to: (i) rotate the first and second reflectors about respective vertical axes and (ii) raise the first antenna reflector to a first antenna position while lowering the second antenna reflector to a second antenna position such that the second antenna reflector avoids shading the first antenna reflector from the radio waves.

### CROSS-REFERENCE TO RELATED APPLICATION

This application claims the benefit of U.S. Provisional Application Ser. No. 62/782,962 filed on Dec. 20, 2018. Further, the U.S. Provisional Application Ser. No. 62/782,962 is incorporated herein by reference in its entirety.

### FIELD OF TECHNOLOGY

An improved antenna and radome assembly is disclosed. Improvements are applicable to aircrafts.

### BACKGROUND

Antenna and radome assemblies are often employed on aircrafts. The radomes of these assemblies are generally configured to protect the one or more antennae in the assemblies. For example, when employed in an aircraft, the radome conducts the airflow in the respective area in order to avoid generation of vortices, while protecting the one or more antenna within from accumulating ice during freezing rain weather events. Further, the radome protects the antenna(s) from debris during flight.

While a radome serves to protect any antenna within the radome, radomes are generally transparent to radio waves so that such antenna can carry out radar duties and/or carry out communication duties.

When a radome/antenna assembly is employed by an aircraft, the radome is generally configured to reduce drag during operation of the aircraft. Since drag is often a consideration for an aircraft radome, the location of the radome on an aircraft is also a consideration. Often, a radar antenna/radome assembly is positioned in the nosecone of an aircraft. Accordingly, the drag created by such an assembly is minimized.

Space in a nosecone, however, is generally limited. As such, there may not be room in the nosecone for additional antennae, such as a K-band (e.g., Ku-band and Ka-band) antenna. Further, a nosecone of an aircraft may not always be the optimal location for a particular antenna. For example, if an antenna is configured to communicate with a geostationary satellite, the antenna needs to be able to receive signal from a relatively fixed position in the sky while traveling generally towards or away from that position. While a nosecone-shaped radome may be transparent to the satellite signal when the aircraft is generally travelling towards the satellite, the remainder of the aircraft may not be transparent to that signal when travelling away from the fixed position of the satellite.

As such, there is a need for improvements in antenna/radome assemblies.

### BRIEF DESCRIPTION OF THE DRAWINGS

FIG. 1A illustrates a perspective view of an aircraft having an exemplary antenna/radome assembly;

FIG. 1B illustrates a perspective view of the antenna/radome assembly of FIG. 1A;

FIG. 2A illustrates a perspective view of an exemplary antenna assembly;

FIG. 2B illustrates a perspective view of an operational envelope of the antenna assembly of FIG. 2A;

FIG. 3 is a flowchart setting forth an exemplary technique for assembling an antenna/radome assembly;

FIG. 4A illustrates a perspective view of another exemplary antenna assembly;

FIG. 4B illustrates a perspective view of the exemplary antenna assembly of FIG. 4A with the reflector rotated about two axes of rotation; and

FIG. 5 is a flowchart setting forth another exemplary technique for assembling an antenna/radome assembly.

### DETAILED DESCRIPTION

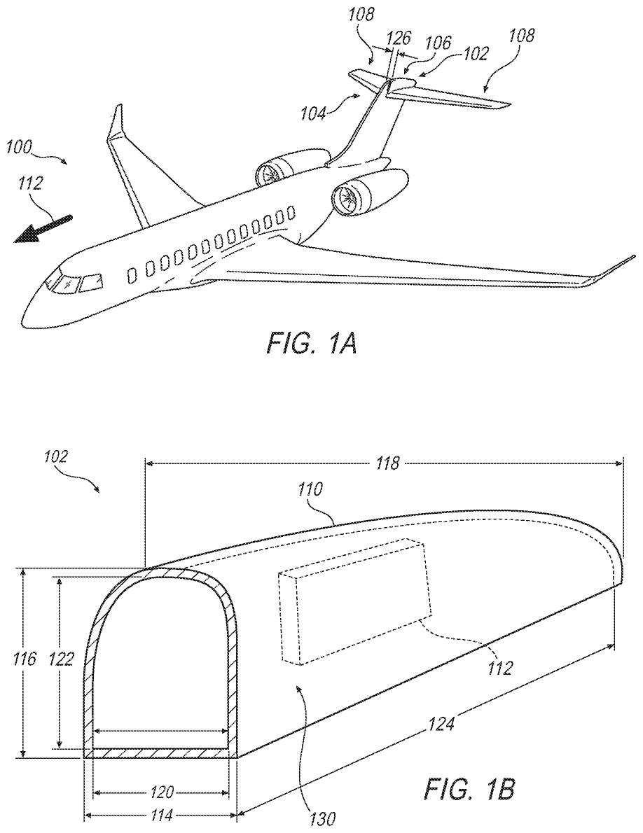

FIG. 1A illustrates a perspective view of an exemplary aircraft 100 having an exemplary antenna/radome assembly 102. As shown, the antenna/radome assembly 102 is configured to be coupled to a tail portion 104 of the aircraft 100. That is, the antenna/radome assembly 102 is configured to be incorporated into an upper vertical stabilizer 106 of the tail portion 104 of the aircraft 100. The upper vertical stabilizer 106 is positioned above the horizontal stabilizer (a.k.a. tailplane) 108 of the tail portion 104 of the aircraft 100. The antenna/radome assembly 102 can be configured to operate with a variety of radio waves. For example, the antenna/radome assembly 102 can be configured to operate via K-band (e.g., Ka-band and/or Ku-band) communications or communications employing higher frequencies. As such, data and/or voice communications can be provided to passengers (not shown) on the aircraft 100.

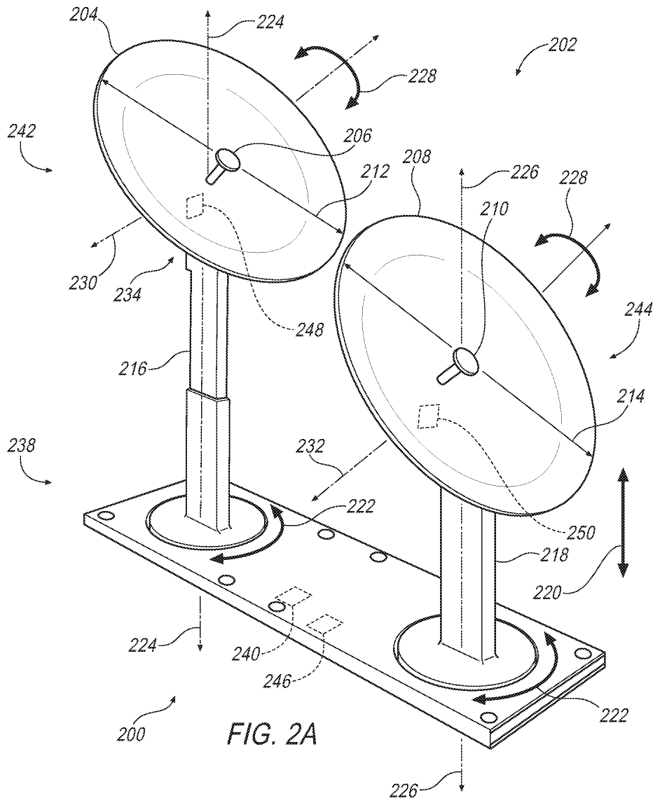

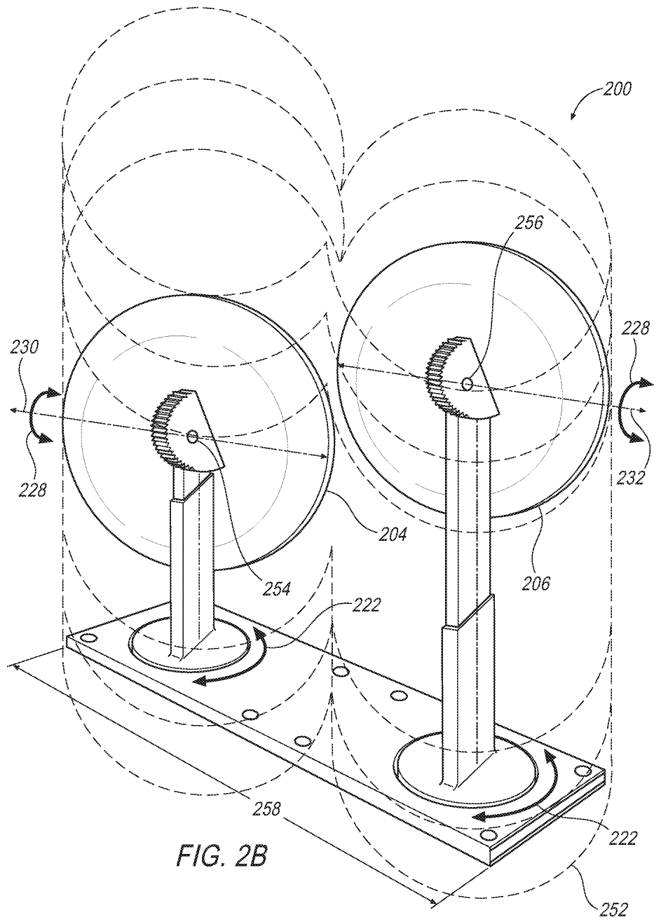

Referring now to FIG. 1B, a perspective view of a portion of the antenna/radome assembly 102 of FIG. 1B is shown. The antenna/radome assembly 102 includes a portion of the radome 110 and an antenna assembly 112 within the portion of the radome 110. The portion of the radome 110 may serve as a portion of the upper tail stabilizer (see the upper tail stabilizer 106 of FIG. 1A). While the antenna assembly 112 is merely shown as a representative box, further details regarding antenna assemblies will be set forth below with respect to FIGS. 2A-5.

Referring back to FIGS. 1A and 1B, the radome 110 provides protection to the antenna assembly 112 from the weather during operation and debris, while at the same time being substantially transparent to radio waves. Further, due to the shape of the radome 110, drag is minimized during operation of the aircraft 100. While not shown, other exemplary radomes may have different shapes than that shown in FIGS. 1A and 1B, or be placed differently within the upper vertical stabilizer 106 of the aircraft 100 than shown in FIG. 1A.

With reference to both FIGS. 1A and 1B, the radome 110 has an outer cross-sectional width 114, an outer cross-sectional height 116, and an outer cross-sectional length 118. In turn, the radome 110 also has an inner cross-sectional width 120, an inner cross-sectional height 122, and an inner cross-sectional length 124.

Often an upper vertical stabilizer width 126 (see FIG. 1A) of the upper tail stabilizer 106 limits the size of the radome 110 that can be placed on top of the vertical stabilizer 106 of the aircraft 100. For example, generally the outer width 114 of the radome 110 should not be greater than the upper vertical stabilizer width 126 since it could affect airflow over adjacent zones of the horizontal stabilizer 108. As such, the outer radome width 114 of the exemplary radome 110, is configured to be generally equal to the upper vertical stabilizer width 126. It is noted that the inner cross-sectional width 120, the upper vertical stabilizer width 126, and the outer radome width 114 are substantially perpendicular to a direction of travel 128 of the aircraft 100.

As will be discussed below, the antenna asembly 112 is configured to operate within a radome envelope 130. In other words, the antenna assembly is configured to operate within the inner volumetric dimensions 130 of the radome 110.

With reference now to FIG. 2A, a perspective view an exemplary antenna assembly 200 is shown. The antenna assembly is configured to fit within a radome (e.g., radome 110 of FIGS. 1A and 1B) that is dimensioned to properly fit (or be integrated into) an upper vertical stabilizer (e.g., upper verticcal stabilizer 106) of an aircraft. Further details regarding radome and antenna assembly 200 interaction will be set forth below with respect to FIG. 2B.

With continued refference to FIG. 2A, the antenna assembly 200 includes an antenna array 202 having a first reflector 204, a first antenna 206, a second reflector 208, and a second antenna 210. The first reflector 204 reflects and focuses radio waves (e.g., k-band communications) to the first antenna 206 and the second reflector 208 refelects and focuses radio waves to the second antenna 210. Each antenna 206, 210 may be capable of sending and/or receiving radio waves. For example, each antenna 206, 210 may be capable of sending and/or receiving K-band (e.g., Ka-band and/or Ku-band) or higher frequency communications. Accordingly, via these communications, communication access such as internet access, text data access, and/or voice data access may be provided to one or more passengers (not shown) of the aircraft (e.g., aircraft 100 of FIG. 1A).

The first reflector 204 of FIG. 2A has a first diameter 212 and, accordingly, a first surface area. The second reflector 208 has a second diameter 214 and, accordingly, a second surface area. The first diameter 212 may or may not be equal to the seccond diameter 214.

Since the first reflector 204 and the second reflector 208 function together as the antenna array the aperture surface area of the antenna array is substantially equal to the sum of the first surface area of the first reflector 204 and the second surface area of the second reflector 208. Accordingly, the antenna array 202 may have the same or greater signal gathering capacity as a single refelector (not shown) with a diameter greater than each of the first and second diameters 212, 214.

With continued reference to FIG. 2A, the first reflector 204 is coupled to a first telescoping arm 216 and the second reflector 208 is coupled to a second telescoping arm 218. Each telescoping arm 216, 218 is configured to move up and down in a vertical direction 220. As such, each reflector 204, 208 can be raised or lowered.

Further, each reflector 204, 208 may be rotated 222 about a vertical axis 224, 226 along the respective telescoping arm 216, 218 and also rotated 228 about a respective horizontal axis 230 232 passing through a top portion 234 236 of each respective telescoping arm 216, 218. The horizontal axes 230, 232 are generally perpendicular to the respective vertical axes 224, 226.

The antenna assembly 214 is configured to track satellite(s) (not shown). That is, the reflectors 204, 208 may be positioned via rotation 222 about the respective vertical axis 224, 226, rotation 228 about the respective horizontal axis 230, 232, and/or telescopic movement of each telescoping arm 218, 218 along the vertical direction 220 to track a satellite.

Among other things, the telescopic movement of the telescoping arms 216, 218 allows the reflectors 204, 208 to positioned to avoid shading (i.e., to avoid having one reflector block radio waves from reaching the other reflector) during tracking. For example, with respect to FIG. 2A, the vertical positions of the first and second reflectors 204, 208 are set so that the second reflector 208 does not shade the first reflector 204 from radio waves received from a satellite. Depending on the position of the satellite being tracked, the respective vertical positions of the reflectors 204, 208 (and corresponding antennas 206, 210 can be changed to avoid shading to maximize signal strength). Though not shown in FIG. 2A, the first and second telescoping arms 216, 218 may be positioned so that the first and second reflectors 204, 208 are at the same height, or so that the first reflector 204 is lower than the second reflector 208.

As discussed above, the reflectors 204, 208, and respective antennas 206, 210 can be rotated 222 about the respective vertical axis 224, 226 to track a satellite (not shown) during aircraft travel. Further, the reflectors 204, 208 may also be rotated 228 about the respective horizontal axis 230, 232 to also aid in satellite tracking. The first telescoping arm 216 and the second telescoping arm 218 are spaced sufficiently far apart from each other such that the first reflector 204 does not make contact with the second reflector 208 during rotation 222 about the vertical axes 224, 226 or rotation 228 about the horizontal axes 230, 232 when the telescopic arms 216, 218 are at any position along the vertical direcction 220.

In addition to the reflectors 204, 208, antennas 206, 210, and telescopic arms 216, 218, the antenna assembly 200 also includes an antenna positioning system 238. The antenna positioning system 238 is configured to simultaneously rotate the first reflector 204 about the first vertical axis 224 along with the first telescoping arm 216 and the second reflector 208 about the second vertical axis 226 along with the second telescoping arm 218. To accomplish this task, the antenna positioning system 238 may include a first motor 240 to simultaneously rotate (i.e., reposition) 222 each reflector 204, 208 about the respective vertical axis 224, 226 via rotation of the respective telescoping arm 216, 218. As such, the azimuth angle of each reflector 204, 208 can be simultaneously adjusted via the first motor 240 during tracking to maximize signal strength. The first motor 240 may, for example, carry out at least 360 degrees or rotation of the first and second telescoping arms 216, 218 to adjust the azimuth angle of the first and second reflectors 204, 208

The antenna positioning system 238 is also configured to raise the first reflector 204 to a first antenna position 242 while lowering the second reflector 208 to a second antenna position 244 such that the second reflector 208 does not shade the first reflector 204 from radio waves in order to maximize signal strength. The antenna positioning system 238 may also place the reflectors 204, 208 in other positions not shown so that one reflector does not shade another reflector. To accomplish these tasks, the antenna positioning system 238 may also include a second motor 246 to simultaneously adjust the position of each reflector 204, 208 along its respective vertical axis 224, 226. For example, the second motor 246 may cause the first telescoping arm 216 to rise while it simultaneously lowers the second telescoping arm 218. In addition, the second motor 246 may cause the first telescoping arm 216 to lower while it raises the second telescoping arm 218. Accordingly, the vertical positions of the first reflector 204 and the second reflector 208 along the respective vertical axes 224, 226 can be simultaneously changed via the second motor 246. In some instances, the first reflector 204 may be in a position higher than the position of the second reflector 208 (see e.g., FIG. 2). And yet in other instances not shown, the first reflector 204 may be at the same vertical position as the second reflector 208, or the first reflector 204 may be at a lower vertical position than the vertical position of the second reflector 208.

The antenna positioning system 238 may also include a third motor 248 and a fourth motor 250. The third motor 248 may be configured to rotate 228 the first reflector 204 about the first horizontal axis 230 and the fourth motor 250 may be configured to rotate 228 the second reflector 208 about the second horizontal axis 232. As such, the zenith angle of each reflector 204, 208 may be changed.

With regard to the antenna positioning system 238, the first, second, third, and fourth motors 240, 246, 248, 250 may be positioned as shown, or at other locations not shown. Further, other exemplary antenna positioning systems not shown may employ more or less motors than those 240, 246, 248, 250 shown in FIG. 2A. For example, an exemplary antenna positioning system (not shown) may employ a single motor and a plurality of gears that may be selectively engaged to cause the various rotations 222, 228 of the reflectors 204, 208 or height adjustments 220 of the telescopic arms 216, 218. In yet another example, other motor configurations not shown may be employed to allow independent control of each degree of freedom of each reflector 204, 208. That is, the antenna positioning system may allow for independent control of the rotation 222 of each reflector 204, 208 about its respective vertical axis of rotation 224, 226. Similarly, the antenna positioning system may also allow for independent control of the raising and lowering 220 of each reflector 204, 208 and accompanying antennas 206, 210. Such control may allow for fine-tuned adjustments of each reflector 204, 208 separately.

With reference now to FIG. 2B, an exemplary operational envelope 252 of the antenna assembly 200 of FIG. 2A is shown.

For representative purposes, the first and second reflectors 204, 208 are shown in positions different than those represented in FIG. 2A. A point of rotation 254 of the first reflector 204 about the first horizontal axis 230 along with a point of rotation 256 of the second reflector 208 about the second horizontal axis 232 are also shown in FIG. 2B.

The exemplary operational envelope 252 illustrates the conceptual idea of a maximum swept-out volume that may be created by the antenna array 202 during operation. That is, the operational envelope 252 represents the maximum volumetric boundaries that may be swept out by the antenna array 202 during satellite tracking operations. The antenna array 202 is configured such that its operational envelope 252 fits within the radome envelope (e.g., radome envelope 130 of FIG. 1B). It is noted that the antenna assembly 200 is configured to be positioned within a radome such that its base length 258 is parallel with the direction of travel (e.g., the direction of travel 128, FIG. 1A) of the aircraft (e.g., aircraft 100, FIG. 1B). In other words, the base length 258 is configured to run parallel with the radome length (e.g., radome length 118 of FIG. 1B). Further, the antenna assembly 200 may be positioned within a radome (e.g., the radome 110 of FIG. 2B) such that the first telescoping arm 216 and the second telescoping arm 218 are each equidistant from two opposite lateral walls of the radome when the reflectors are pointed in the direction of travel of the aircraft.

Many antennas, such as k-band antennas, require a circular reflector diameter of about 30 centimeters (12 inches) or greater in order to gather enough signal for proper operation. Reflectors this size along with the accompanying radome needed to protect them, however, are often too large to be placed within the allowable footprint on the upper tail stabilizer (e.g., upper tail stabilizer 106 of FIG. 1A) of many aircrafts. Though not shown, the operational envelope of a single circular antenna having a diameter of, for example, 30.48 centimeters would not fit into a radome envelope having an inner width less than 30.48 centimeters. Often, a limiting space requirement is the cross-sectional width (e.g., cross-sectional width 126, FIG. 1A) of the upper tail stabilizer (e.g., tail stabilizer 106). If, for example, the upper vertical stabilizer width is approximately 30 centimeters or less, a radome that houses a reflector with a circular antenna having a diameter of 30 centimeters or greater will not fit on such an aircraft. That is, the radome needed to accommodate the circular antenna would need an outer cross-sectional width greater than 30 centimeters. As such the reflector diameter should be less than the upper vertical stabilizer width.

The exemplary antenna assembly 200 of FIGS. 2A and 2B, however, is configured to properly operate within the space restrictions defined by many aircraft tails. The reflector 204, 208 diameters 212, 214 are chosen such that the antenna array 202 can gather enough signal to operate properly and that once such array 202 is housed by a radome (e.g., radome 110 of FIG. 1), the radome/antenna assembly will fit within an allowable tail footprint. The sum of surface areas of the first and second reflectors 204, 208 may be greater than or equal to the surface area of a single circular reflector having a diameter of about 30 centimeters. As such, the antenna assembly 200 of FIGS. 2A and 2B can properly operate in conditions where a single circular antenna having a diameter of about 30 centimeters (roughly 12 inches) is needed, but space restrictions cannot accommodate such a diameter. For example, an array with two circular antennas each having a diameter of 21.55 centimeters has approximately the same surface area as a single antenna having a diameter of about 30 centimeters.

As mentioned, the operational surface area of the array (i.e., the sum of the reflector surface areas) may be greater than the surface area of a single circular antenna having a diameter of about 30 inches. For example, if each antenna in the array had a diameter of 20 centimeters, the operational surface area of the array would be greater than the surface area of a single antenna with a diameter of roughly 30 centimeters. As such, the antenna assembly array 202 of FIGS. 2A and 2B may be able to gather more signal than a single reflector having a diameter of roughly 30 cm.

While FIG. 2B illustrates an operational envelope 252 of the array 202, arrays having different operational envelopes (not shown) may be employed. The operational envelope size and shape can vary based on (i) the size and shape of the reflectors, (ii) the extent the reflectors can rotate about the horizontal and vertical axes, and (iii) the extent the reflectors can move in the vertical direction.

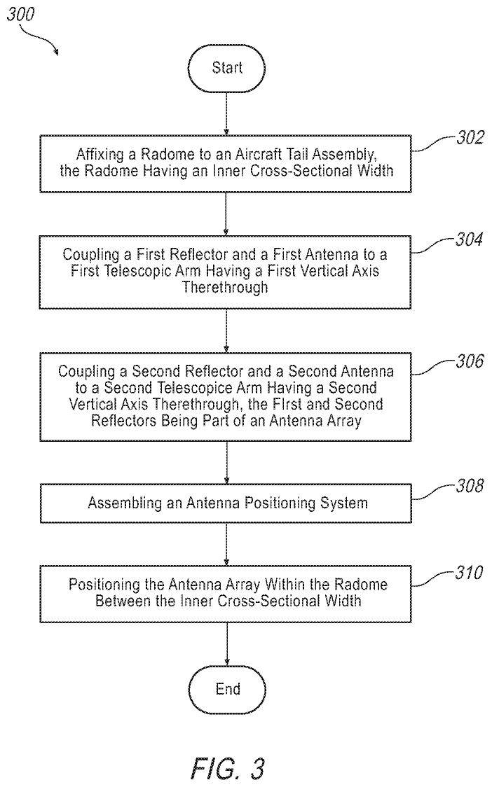

Referring now to FIG. 3, a flowchart illustrates an exemplary technique 300 for assembling an antenna/radome assembly. The exemplary process control begins at BLOCK 302 where affixing a radome to an aircraft tail assembly occurs. The radome has an inner cross-sectional width less than twelve inches (30.48 centimeters) and the inner cross-sectional width is substantially perpendicular to a direction of travel of the aircraft tail assembly. Process control then proceeds to BLOCK 304, where coupling a first reflector and a first antenna to a first telescopic arm having a first vertical axis therethrough occurs. The first reflector has a first surface area.

After coupling the first reflector and first antenna to the first telescopic arm, process control proceeds to BLOCK 306 to carry out coupling of a second reflector and a second antenna to a second telescopic arm having a second vertical axis therethrough. The second reflector has a second surface area. The surface areas of the first and second reflectors may or may not be equal.

A sum of the first surface area and the second surface area may be equal to or greater than a surface are of a twelve inch (30.48 centimeter) diameter circular radio wave reflector (not employed). Further, the antenna array may be configured to receive K-band communications (or communications at higher frequencies) that allow the aircraft to provide communication access to passengers.

Process control next carries out assembling an antenna positioning system at BLOCK 308. The antenna positioning system is configured to: (i) rotate the first reflector about a first horizontal axis perpendicular to the first telescoping arm; (ii) rotate the second reflector about a second horizontal axis perpendicular to the second telescoping arm; (iii) raise the first reflector while lowering the second reflector such that the second reflector does not shade the first reflector from radio waves during operation of the antenna array; and (iv) simultaneously rotate the first reflector about the first vertical axis and the second reflector about the second vertical axis.

Assembling the antenna positioning system may include: coupling a first motor to the antenna array to rotate the first reflector about the first vertical axis while simultaneously rotating the second reflector about the second vertical axis; coupling a second motor to the antenna array to raise the first reflector via the first telescoping arm while lowering the second reflector via the second telescoping arm; coupling a third motor to the antenna array to cause the first reflector to rotate about the first horizontal axis; and/or coupling a fourth motor to the antenna array to cause the second reflector to rotate about the second horizontal axis.

After assembling the antenna positioning system, process control proceeds to BLOCK 310, where positioning the antenna array within the radome between the inner cross-sectional width is carried out. Process control then proceeds to an end.

While an order of exemplary technique 300 is set forth via the order to BLOCKS 302-310, other techniques need not employ such an order. That is, the affixing of the radome at BLOCK 302, the coupling of the first reflector at BLOCK 304, the coupling of the second reflector at BLOCK 306, the assembling of the antenna positioning system at BLOCK 308, and the positioning of the antenna array at BLOCK 310 may occur in any order.

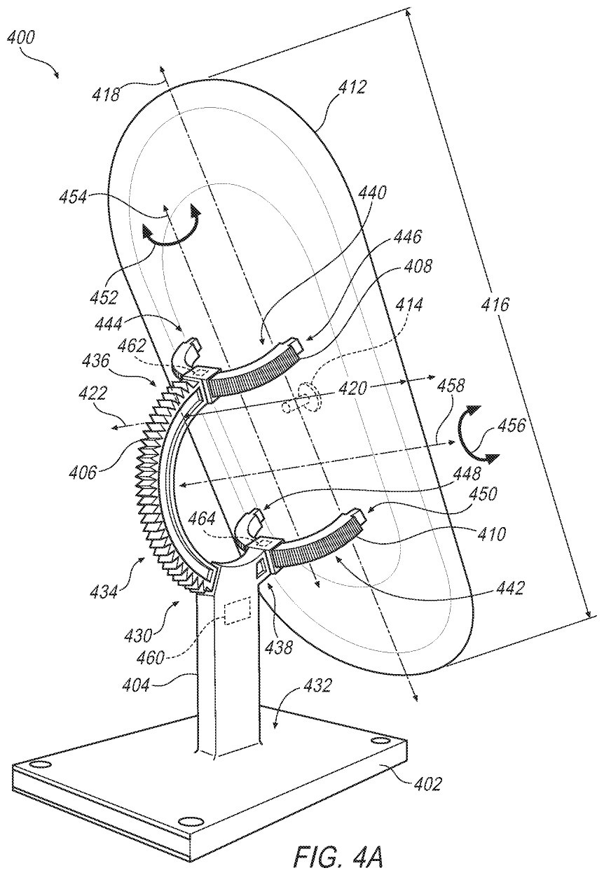

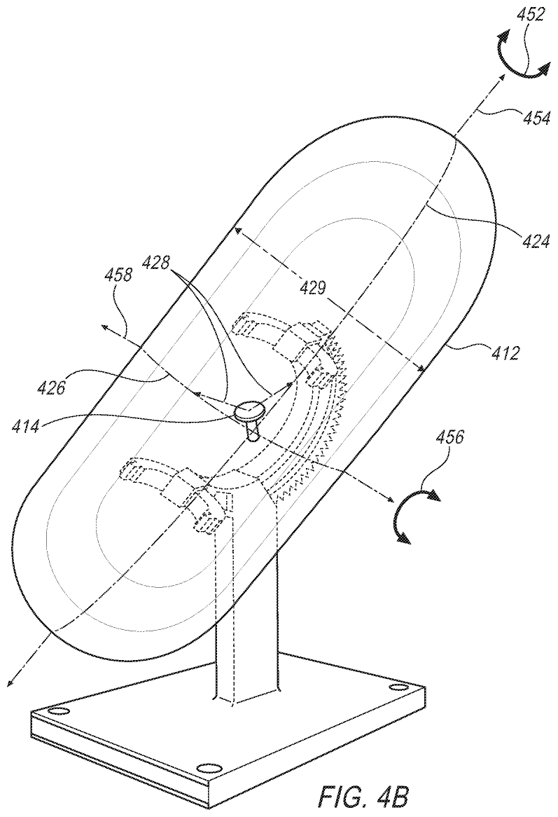

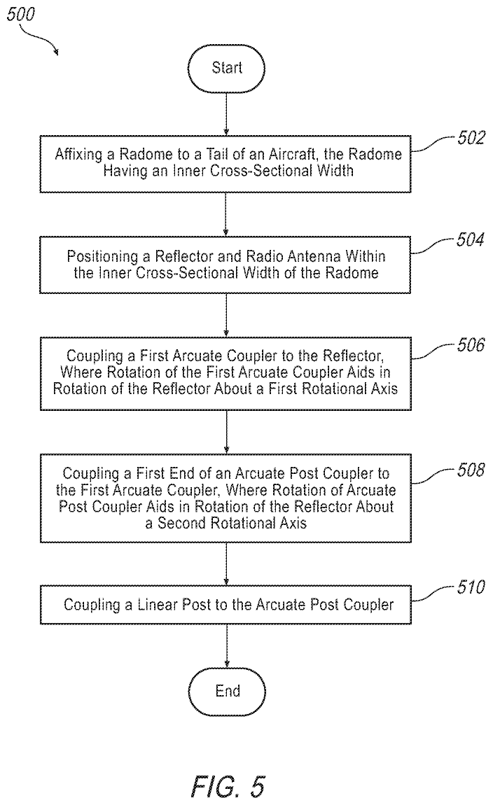

With reference now to FIG. 4A, a perspective view of another exemplary antenna assembly 400 is shown. The antenna assembly 400 is configured to be positioned within a radome having limited space requirements. For example, the antenna assembly 400 may be configured to fit within a radome having an inner cross-sectional width less than twelve (12) inches or 30.48 centimeters (see e.g., radome 110 of FIGS. 1A and 1B). Though not shown, the operational envelope (see e.g., the operational envelope 252 of FIG. 2B) of the antenna assembly 400 is configured to fit within a radome configured to be integrated into an upper vertical stabilizer (e.g., the upper vertical stabilizer 106 of FIG. 1A).

The antenna assembly 400 of FIG. 4A includes a base 402, a linear post 404 extending vertically from the base 402, a post coupler 406, a first antenna coupler 408, a second antenna coupler 410, a reflector 412 (rear-side of reflector shown), and an antenna 414.

The reflector 412 is configured to reflect and focus radio waves to the antenna 414. The radio waves may be K-band or higher frequency communications to allow passenger access to an internet connection and/or or other data connections (e.g., voice or text connections).

The reflector 412 has a first or major diameter 416 along a major axis 418 and a second or minor diameter 420 along a minor axis 422. The major axis 418 is substantially perpendicular to the minor axis 422. The first diameter 416 is greater than the second diameter 420. Further, the second diameter 420 is less than the upper vertical stabilizer width (e.g., the upper vertical stabilizer width 126 of FIG. 1A).

The second diameter 420 of the reflector 412 along the minor axis 422 may be less than twelve (12) inches or 30.48 centimeters. For example, the second diameter 420 may be less than 10.4 inches (approximately 26.42 centimeters). Accordingly, the reflector 412 may be positioned within the inner cross-sectional width of a radome (e.g., radome 110 of FIGS. 1A and 1B), where the inner cross-sectional width is 10.4 inches (26.416 centimeters).

Referring now to FIG. 4B, another perspective view of the exemplary antenna assembly 400 of FIG. 4A is shown. The reflector 412 of the assembly 400 has a first parabolic contour (or cross-section) 424 generally along the major axis 418 and a second parabolic contour (or cross-section) 426 generally along the minor axis 422. Each parabolic contour 424, 426 may share a same parabolic focus 428. In other words, the parabolic focus 428 of each parabolic contour 424, 426 may be equal to one another. In such a case, these parabolic contours 424, 426 are not elliptical contours with two foci.

Due to the shape of the reflector 412, the surface area of the reflector is greater than or equal to the surface area that corresponds with many circular reflectors (not shown) having a diameter of twelve inches (30.48 centimeters).

Further, since the radome width (e.g., inner cross-sectional width 120 of radome 110 of FIG. 1B) limits the size of reflector(s) that may be employed, the non-circular reflector 412 maximizes aperture surface area in the limited space allowed by the radome. For example, with reference to FIG. 4B, it is noted that the non-circular reflector 412 has a first width 429. However, due to the non-circular shape of the reflector 412, the reflector 412 has a greater aperture surface area than a circular reflector (not shown) having a diameter equal to the first width 429. As such, the non-circular reflector 412 maximizes aperture surface area that can be fit within a radome.

As shown in FIGS. 4A and 4B, the perimeter of the reflector 412 includes generally parallel sides that join two semi-circular ends. The reflector 412, however, may take on other exemplary non-circular shapes. For example, though not shown, a reflector having a truncated circular shape may be employed. That is, the perimeter of the reflector may have the appearance of a circle having two opposing sides removed. As another example, the reflector may include two half-circle ends joined by parallel sides. Other reflector shapes, not shown, that maximize aperture surface area may also be employed.

Referring back to FIG. 4A, the post 404, which is coupled to the reflector 412 via the couplers 406-410, includes a first end 430 and a second end 432 opposite the first end 430. The second end 432 of the post 404 may be fixedly coupled to the base 402, and the first end 430 is coupled to an arc 434 of the post coupler 406.

The post coupler 406 also includes a first end 436 and a second end 438. The first end 436 of the post coupler 406 is coupled to an arc 440 of the first coupler 408 and the second end 438 of the post coupler 406 is coupled to an arc 442 of the second coupler 410.

The first coupler 408 also includes a first end 444 and a second end 446. Each end 444, 446 is coupled to the reflector 412. Similarly, the second coupler 410 includes a first end 448 and a second end 450, where each end 448, 450 is coupled to the reflector 412.

As the arc 440 of the first antenna coupler 408 passes through the first end 436 of the post coupler 406 while the arc 442 of the second coupler 410 passes through the second end 438 of the post coupler 406, the reflector 412 rotates 452 about a first rotational axis 454 that is substantially parallel to the major axis 418 of the reflector 412. Accordingly, the azimuth angle of the reflector 412 may be changed.

As depicted in FIG. 4A, the first axis of rotation 454 passes between the first and second ends 444, 446 of the first coupler 408 and between the first and second ends 448, 450 of the second coupler 410. Other examples not shown, however, may have the first axis of rotation 454 not passes through the first and second ends 444, 446 of the first coupler 408 and the first and second ends 448, 450 of the second coupler 410.

Further, though not shown, differing shaped first and second couplers may cause the first rotational axis 454 to be coincident with the major axis 418. In such an instance, since the first axis of rotation 454 would be coincident with the major axis 418 of the reflector 412, the reflector 412 would rotate about the major axis 418 via the first and second couplers 408, 410.

In addition to the first axis of rotation 454, the reflector also rotates 456 about a second axis of rotation 458. As the arc 434 of the post coupler 406 passes through the first end 430 of the post 404, the reflector 412 rotates 456 about the second rotational axis 458 that is substantially parallel to the minor axis 422. Accordingly, the zenith angle of the reflector 412 can be changed.

Though not shown, a differing shaped post coupler may make the first rotational axis 458 coincident and with the minor axis 422. In such an instance, since the second axis of rotation 458 would be coincident with the minor axis 422 of the reflector 412, the reflector 412 would rotate about the minor axis 422 via the post coupler 406.

A comparison of FIG. 4A to 4B illustrates the rotation of the reflector 412 about the two axes of rotation 454, 458. The reflector 412 rotates about no more than the first axis of rotation 454 and the second axis of rotation 458. The antenna assembly 400 may include a first motor 460 that causes movement of the post coupler 406 through the first end 430 of the post 404, thus causing the reflector to rotate 456 about the second axis of rotation 458. The antenna assembly 400 may also include a second motor 462 near the first end 436 of the post coupler 406 and/or a third motor 464 near the second end 438 of the post coupler 406. The second and/or third motors 462, 464 may cause the first coupler 408 to pass through the first end 436 of the post coupler 406 and the second coupler 410 to pass through the second end 438 of the post coupler 406 to cause the reflector 412 to rotate 452 about the first axis of rotation 454. Other exemplary antenna assemblies (not shown) may employ different quantities and/or configurations of motors to cause rotation about the first and second axes of rotation 454, 458.

Referring now to FIG. 5, a flowchart depicts another exemplary technique 500 for assembling an antenna/radome assembly for an aircraft.

Process control begins at BLOCK 502, where affixing a radome to a tail of the aircraft occurs. The radome has an inner cross-sectional diameter less than twelve inches (30.48 centimeters). Process control then proceeds to BLOCK 504 for positioning a reflector and radio antenna within the inner cross-sectional width of the radome. The reflector has a major diameter along a major axis greater than a minor diameter along a minor axis. Further, the reflector has a first arcuate contour along the major axis and a second arcuate contour along the minor axis.

A surface area of the reflector may be equal to or greater than a surface area of a twelve inch (30.48 centimeter) diameter circular radio wave reflector. Further, the radio antenna may be configured to send and receive K-band or higher frequency communications via the reflector to provide internet connectivity (or other data and/or voice connectivity) to passengers of the aircraft.

After positioning the reflector and radio antenna, process control proceeds to BLOCK 506 for coupling a first arcuate coupler to the reflector, where rotation of the first arcuate coupler aids in rotation of the reflector about a first rotational axis substantially parallel to the major axis. Coupling of a first end of an arcuate post coupler to the first arcuate coupler then occurs at BLOCK 508. Rotation of the arcuate post coupler aids in rotation of the reflector about a second rotational axis substantially parallel to the minor axis.

Next, process control proceeds to BLOCK 510 for coupling a linear post to the arcuate post coupler.

In addition to BLOCKS 502-510, technique 500 may include additional BLOCKS (not shown) for: (i) coupling a second arcuate coupler to the reflector; (ii) coupling a second end of the arcuate post coupler to the second arcuate coupler, where rotation of the second arcuate coupler along with the rotation of the first arcuate coupler aids in the rotation of the reflector about the first rotational axis; and (iii) coupling a first end of a vertical post to an arc of the arcuate post coupler.

While an order of exemplary technique 500 is set forth via the order to BLOCKS 502-510, other techniques need not employ such an order. That is, the affixing of the radome at BLOCK 502, the positioning of the reflector at BLOCK 504, the coupling of the first arcuate coupler at BLOCK 506, the coupling a first end of the arcuate post coupler at BLOCK 508, and the coupling of the linear post to the arcuate post coupler at BLOCK 510 may occur in any order.

As discussed above with respect to FIGS. 1A and 1B, radomes (e.g., radome 110) may impose size constraints on antenna assemblies. For example, in one illustrative approach the inner cross-sectional width 120 of the radome 110 of FIGS. 1A and 1B is less than approximately twelve (12) inches or 30 centimeters. As such, a circular antenna (not shown) having a reflector diameter of twelve inches (30.48 centimeters) or more would not fit in the radome 110 of FIGS. 1A and 1B. However, an array of smaller antennas such as antenna array 210 of FIG. 2, may fit within the radome 110 while at the same time having an array surface area greater than or equal to a single circular antenna (not shown) having a reflector of twelve inches (30.48 centimeters) or more. Similarly, the antenna assembly 400 of FIG. 4 with the reflector 412 having a second diameter 420 along the minor axis 422 being less than twelve inches (30.48 centimeters) may also fit within a radome having the inner width 120 (FIG. 1B) less than twelve inches. Further, due to the shape of the reflector 412 of the antenna assembly 400 of FIG. 4, the reflector 412 may have a surface area greater than or equal to a surface provided by a circular 30.48 centimeter diameter reflector (not shown) even if the reflector 412 has a second diameter 420 less than 30.48 centimeters.

The antenna assemblies 112, 200, 400 respectively of FIGS. 1A-2 and 4A-4B, may be scaled to fit within a radome having an inner width (e.g., inner width 120 of FIG. 1) of 26.416 centimeters or less. At the same time, the aperture surface area of each antenna assembly 112, 200, 400 may be equal to or greater than an effective aperture surface area of an antenna having a circular reflector with a diameter of at least 30.48 centimeters.

With regard to FIGS. 1A-5 and the processes, systems, methods, techniques, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description or Abstract below, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary. Further, the use of terms such as “first,” “second,” “third,” and the like that immediately precede an element(s) do not necessarily indicate sequence unless set forth otherwise, either explicitly or inferred through context.

1. An assembly for an aircraft comprising:
a radome configured to be mounted to an upper vertical stabilizer of an aircraft and having an inner cross-sectional width substantially perpendicular to a direction of travel of the aircraft;
a first antenna reflector positioned within the cross-sectional width of the radome and coupled to a first telescoping arm configured to move in a vertical direction, the first antenna reflector having a first surface area;
a second antenna reflector positioned within the cross-sectional width of the radome and coupled to a second telescoping arm configured to move in the vertical direction, the second antenna reflector having a second surface area, wherein the first antenna reflector and the second antenna reflector are configured to focus radio waves; and
an antenna positioning system configured to:
rotate the first antenna reflector about a first vertical axis along the first telescoping arm and the second antenna reflector about a second vertical axis along the second telescoping arm; and
raise the first antenna reflector to a first antenna position while lowering the second antenna reflector to a second antenna position such that the second antenna reflector avoids shading the first antenna reflector from the radio waves.

2. The assembly for an aircraft of claim 1 wherein a sum of the first surface area and the second surface area is one of greater than and equal to a surface area of a circular twelve inch diameter reflector antenna, and wherein the radio waves have frequencies at least as high as k-band communication radio waves to provide communication access to at least one aircraft passenger, and wherein the inner cross-sectional width of the radome is less than approximately 30 centimeters.

3. The assembly for an aircraft of claim 1 wherein the antenna positioning system is further configured to maximize signal reception by lowering and the first antenna reflector to a different first antenna position and raising the second antenna to a different second antenna position such that the first antenna avoids shading the second antenna from the radio waves while the antenna positioning system tracks a satellite, and wherein the antenna positioning system raises and lowers the first antenna reflector via the first telescoping arm and raises and lowers the second antenna reflector via the second telescoping arm.

4. The assembly for an aircraft of claim 3 wherein the antenna positioning system is further configured to:
rotate the first antenna reflector about a first horizontal axis perpendicular to the first vertical axis; and
rotate the second antenna reflector about a second horizontal axis perpendicular to the second vertical axis.

5. The assembly for an aircraft of claim 4 further comprising:
a first antenna configured to receive the focused radio waves from the first antenna reflector; and
a second antenna configured to receive the focused radio waves from the second antenna reflector, wherein the radio waves received by the first and second antenna reflectors have frequencies at least as high as k-band radio waves.

6. The assembly for an aircraft of claim 5 wherein the antenna positioning system comprises:
a first motor configured to simultaneously rotate the first antenna reflector and the second antenna reflector respectively about the first vertical axis and the second vertical axis; and
a second motor configured to raise the first antenna reflector while lowering the second antenna reflector such that the second antenna reflector avoids shading the first antenna reflector from the radio waves, wherein the first telescoping arm and the second telescoping arm are each equidistant from two opposing walls of the radome when the reflectors are pointed in the direction of travel of the aircraft.

7. The assembly for an aircraft of claim 6 wherein the antenna positioning system further comprises:
a third motor configured to rotate the first antenna reflector about the first horizontal axis; and
a fourth motor configured rotate the second antenna reflector about the second horizontal axis.

8. An antenna/radome assembly comprising:
a radome configured to be integrated into an upper vertical stabilizer, the radome having a first inner cross-sectional width, wherein the first inner cross-sectional width is substantially perpendicular to a direction of travel of the aircraft;
an antenna array configured to fit within the radome within the first inner cross-section width, the antenna array is configured to receive radio waves and comprises:
a first reflector and a first antenna coupled to a first telescoping arm, the first reflector having a first surface and configured to focus radio waves to the first antenna; and
a second reflector and second antenna coupled to a second telescoping arm, the second reflector having a second surface area and configured to focus radio waves to the second antenna; and wherein the aircraft tail assembly further comprises:
an antenna positioning system configured to:
raise the first reflector via the first telescoping arm while it lowers the second reflector via the second telescoping arm;
lower the first reflector via the first telescoping arm while it raises the second reflector via the second telescoping arm;
rotate the first reflector about a first vertical axis along the first telescoping arm; and
rotate the second reflector about a second vertical axis along the second telescoping arm.

9. The antenna/radome assembly of claim 8 wherein a sum of the first surface area and the second surface area is one of greater than and equal to a surface area of a circular twelve inch diameter reflector antenna, and wherein the radio waves the antenna array is configured to receive have frequencies at least as high as k-band communications to allow the aircraft to provide communication access to passengers.

10. The antenna/radome assembly of claim 9 wherein the antenna positioning system maximizes signal reception and ensures that the first reflector does avoids shading the second reflector from the radio waves and that the second reflector avoids shading the first reflector from the radio waves during operation, and wherein the inner cross-sectional width of the radome is less than 30.48 centimeters.

11. The antenna/radome assembly of claim 10 wherein the antenna positioning system is further configured to:
rotate the first reflector about a first horizontal axis perpendicular to the first vertical axis; and
rotate the second reflector about a second horizontal axis perpendicular to the second vertical axis.

12. The antenna/radome assembly of claim 11 wherein the rotation of the first reflector about the first vertical axis and the rotation of the second reflector about the second vertical axis occurs simultaneously, and wherein the first telescoping arm and the second telescoping arm are each equidistant from two opposing walls of the radome when the reflectors are pointed in the direction of travel of the aircraft.

13. The antenna/radome assembly of claim 12 wherein the antenna positioning system comprises:
a first motor configured to simultaneously rotate the first reflector about the first vertical axis and the second reflector about the second vertical axis; and
a second motor configured to: (i) raise the first reflector via the first telescoping arm while lowering the second reflector via the second telescoping arm and (ii) lower the first reflector via the first telescoping arm while raising the second reflector via the second telescoping arm.

14. The antenna/radome assembly of claim 13 wherein the antenna positioning system further comprises:
a third motor configured to rotate the first reflector about the first horizontal axis; and
a fourth motor configured rotate the second reflector about the second horizontal axis.

15. A method for assembling an antenna/radome assembly comprising:
affixing a radome to an aircraft tail assembly, the radome having an inner cross-sectional width less than a width of the aircraft tail assembly, wherein the inner cross-sectional width and the width of the aircraft tail assembly are substantially perpendicular to a direction of travel of an aircraft;
coupling a first reflector and a first antenna to a first telescopic arm having a first vertical axis therethrough, the first reflector having a first surface area;
coupling a second reflector and a second antenna to a second telescopic arm having a second vertical axis therethrough, the second reflector having a second surface area, wherein the first and second reflectors and the first and second antennas form an antenna array;
assembling an antenna positioning system configured to (i) rotate the first reflector about a first horizontal axis perpendicular to the first telescoping arm, (ii) rotate the second reflector about a second horizontal axis perpendicular to the second telescoping arm, (iii) raise the first reflector while lowering the second reflector such that the second reflector avoids shading the first reflector from radio waves during operation of the antenna array, and (iv) rotate the first reflector about the first vertical axis and the second reflector about the second vertical axis; and
positioning the antenna array within the radome within the inner cross-sectional width.

16. The method of claim 15 wherein a sum of the first surface area and the second surface area is one of equal to and greater than a surface area of a twelve inch diameter circular radio wave reflector, and wherein the antenna array is configured to receive radio frequencies at least as high as frequencies of k-band communications to allow the aircraft to provide communication access to passengers, and wherein the inner cross-sectional width is less than approximately 30 centimeters.

17. The method of claim 16 wherein assembling the antenna positioning system comprises coupling a first motor to the antenna array to rotate the first reflector about the first vertical axis while simultaneously rotating the second reflector about the second vertical axis, wherein the first telescoping arm and the second telescoping arm are each equidistant from two opposite walls of the radome when the reflectors are pointed in the direction of travel of the aircraft.

18. The method of claim 17 wherein assembling the antenna positioning system further comprises coupling a second motor to the antenna array to raise the first reflector via the first telescoping arm while lowering the second reflector via the second telescoping arm.

19. The method of claim 18 wherein assembling the antenna positioning system further comprises coupling a third motor to the antenna array to cause the first reflector to rotate about the first horizontal axis.

20. The method of claim 19 wherein assembling the antenna positioning system further comprises coupling a fourth motor to the antenna array to cause the second reflector to rotate about the second horizontal axis.
